(19) United States
(12) Patent Application Publication
(10) Pub. No.: US 2013/0231943 A1
(43) Pub. Date: Sep. 5, 2013

(54) MEDICAL INFORMATION INPUT APPARATUS

(71) Applicant: OLYMPUS MEDICAL SYSTEMS CORP., Tokyo (JP)

(72) Inventors: Norio FUEKI, Tokyo (JP); Chieko WATANABE, Tokyo (JP); Emiko OUCHI, Tokyo (JP)

(73) Assignee: OLYMPUS MEDICAL SYSTEMS CORP., Tokyo (JP)

(21) Appl. No.: 13/757,904

(22) Filed: Feb. 4, 2013

Related U.S. Application Data
(63) Continuation of application No. PCT/JP2012/004587, filed on Jul. 18, 2012.

(30) Foreign Application Priority Data
Aug. 4, 2011 (JP) 2011-171391

(51) Int. Cl. G06Q 50/22; G06Q 10/06

(52) U.S. Cl. CPC G06Q 50/22; G06Q 10/06
USPC 705/2

(57) ABSTRACT

In a medical information input apparatus, a display control unit generates a first input screen for entering information on medical practices and a second input screen for entering information on academic research. An input reception unit receives information input entered from a user on the first input screen and the second input screen. A recording unit records the information entered through the first input screen and the second input screen. A requirement storage unit stores a requirement for generating the second screen. When a determination unit determines that the information received from the user on the first input screen by the input reception unit satisfies the requirement stored in the requirement storage unit, the display control unit generates the second input screen on condition that a predetermined button created on the first input screen have been pressed.

### CROSS-REFERENCE TO RELATED APPLICATIONS

This application is based upon and claims the benefit of priority from the prior Japanese Patent Application No. 2011-171391, filed on Aug. 4, 2011, the entire contents of which are incorporated herein by reference.

### BACKGROUND OF THE INVENTION

1. Field of the Invention

The present invention relates to an input support technology for implementation data pertaining to examinations or the like.

2. Description of the Related Art

In order to improve operability for data entry, a technology has been suggested as follows. Two display apparatuses are prepared. An image display means then displays form image data that has been transmitted on a first display apparatus, and an input screen control means searches a screen display table for a data input screen that is suitable for a corresponding form by using, as a key, accompanying data that has been transmitted so as to display the data input screen on a second display apparatus (for example, see JP 11-224302).

For the purpose of development in medical technologies, multiple medical facilities such as hospitals and institutions often set a research theme in cooperation and perform academic research in collaboration. By gathering diagnostic information on numerous patients in multiple medical facilities, the reliability of statistical data can be improved, and opportunities can be provided for discussions by many doctors. In order to efficiently collect data from multiple medical facilities, medical facilities participating in academic research install a program for generating data input screen for the academic research in their systems so as to create an environment that allows medical professionals such as doctors to input data exhaustively that is necessary for the academic research.

On a daily basis, when a doctor performs an examination or makes a diagnosis, the doctor puts records thereof together in a report. Therefore, a doctor who has performed an examination or the like that is subject to academic research needs to start a data input screen designated for the academic research so as to enter an examination record for the academic research after the doctor makes a report by entering the examination record in a data input screen designated for daily examination tasks.

However, as is well known, since doctors are often very busy, they often forget to start a data input screen designated for academic research. Therefore, it is preferred to provide a mechanism that prevents a doctor from forgetting to enter data for academic research when the doctor enters a daily examination record. In general, a medical record prepared for academic research is not the same as that for daily tasks. However, sometimes there is some data that is the same. Therefore, it is preferred to provide an input mechanism that does not cause an inconsistency in both medical records.

### SUMMARY OF THE INVENTION

In this background, a purpose of the present invention is to provide a technology for efficiently entering implementation data pertaining to examinations or the like.

An medical information input apparatus according to one embodiment of the present invention includes: a display control unit configured to generate a first input screen for entering information on medical practices and a second input screen for entering information on academic research; an input reception unit configured to receive information input entered from a user on the first input screen and the second input screen; a recording unit configured to record the information entered through the first input screen and the second input screen; a requirement storage unit configured to store a requirement for generating the second input screen; and a determination unit configured to determine whether or not the requirement stored in the requirement storage unit is satisfied. When the determination unit determines that the information received from the user on the first input screen by the input reception unit satisfies the requirement stored in the requirement storage unit, the display control unit generates the second input screen on condition that a predetermined button created on the first input screen has been pressed.

Optional combinations of the aforementioned constituting elements and implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram illustrating the entire configuration of an academic research execution system in an exemplary embodiment of the present invention;

FIG. 2 is a diagram illustrating the configuration of a medical information input apparatus;

FIG. 3 is a diagram illustrating a system start and end screen of an endoscopic examination system;

FIG. 4 is a diagram illustrating an examination task main screen;

FIG. 5 is a diagram illustrating a screen showing a list of examinations unregistered in a report;

FIG. 6 is a diagram illustrating a report input screen;

FIG. 7 is a diagram illustrating a research data input screen;

FIG. 8 is a diagram illustrating a report input screen in which a display button for the research data input screen is created;

FIG. 9 is a diagram illustrating a selection window for selecting an academic research theme;

FIG. 10 is a diagram illustrating another example of a selection window for selecting an academic research theme;

FIG. 11 is a diagram illustrating an example of a GUI for linking master data for academic research to master data for an endoscopic examination;

FIG. 12 is a diagram illustrating an example where master data items are associated with each other;

FIG. 13 is a diagram illustrating a selection window displayed during report entry;

FIG. 14 is a diagram illustrating a condition where an item in the selection window is being selected; and

FIG. 15 is a diagram illustrating a research data input screen.

### DETAILED DESCRIPTION OF THE INVENTION

The invention will now be described by reference to the preferred embodiments. This does not intend to limit the scope of the present invention, but to exemplify the invention.

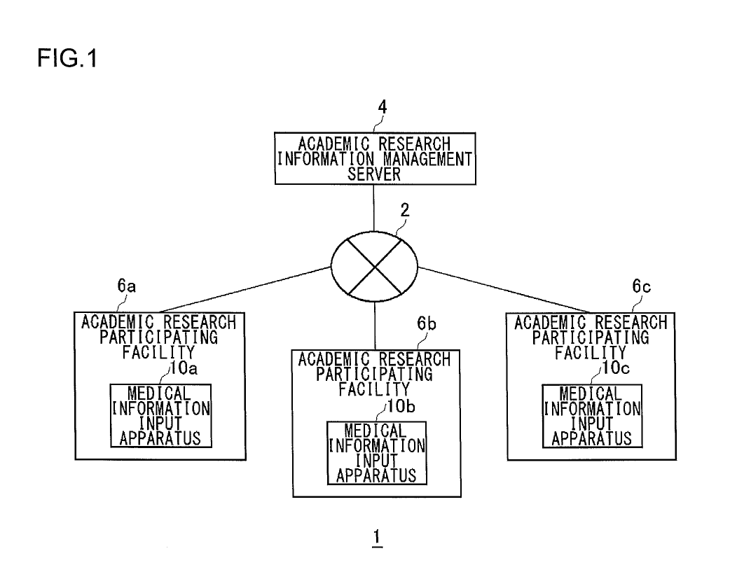

FIG. 1 illustrates the entire configuration of an academic research execution system 1 in an exemplary embodiment of the present invention. In the academic research execution system 1, there exist an academic research information management server 4, which manages information on academic research in an integrated manner, and academic research participating facilities 6a through 6c (hereinafter, referred to as “academic research participating facilities 6” when no distinction is to be made), which participate in the academic research. The academic research information management server 4 provides the academic research participating facilities 6 with master data that is used for the academic research and aggregates implementation data collected by the academic research participating facilities 6 so as to perform a statistical process. The academic research participating facilities 6a through 6c are provided with medical information input apparatuses 10a through 10c (hereinafter, referred to as “medical information input apparatuses 10” when no distinction is to be made) for entering and collecting implementation data used for the academic research.

The academic research information management server 4 and the medical information input apparatuses 10 can exchange data via a network 2 such as the Internet. The academic research information management server 4 transmits, to the medical information input apparatuses 10 via the network 2, a program for generating a data input screen for academic research, a requirement for generating the data input screen for the academic research, and master data that defines data to be collected for the academic research. In the academic research execution system 1, it is not a necessary requirement to connect the academic research information management server 4 with the medical information input apparatuses 10 via the network 2. The program for generating the data input screen for the academic research, and the like may be recorded in a portable recording medium and provided to the medical information input apparatuses 10 off-line.

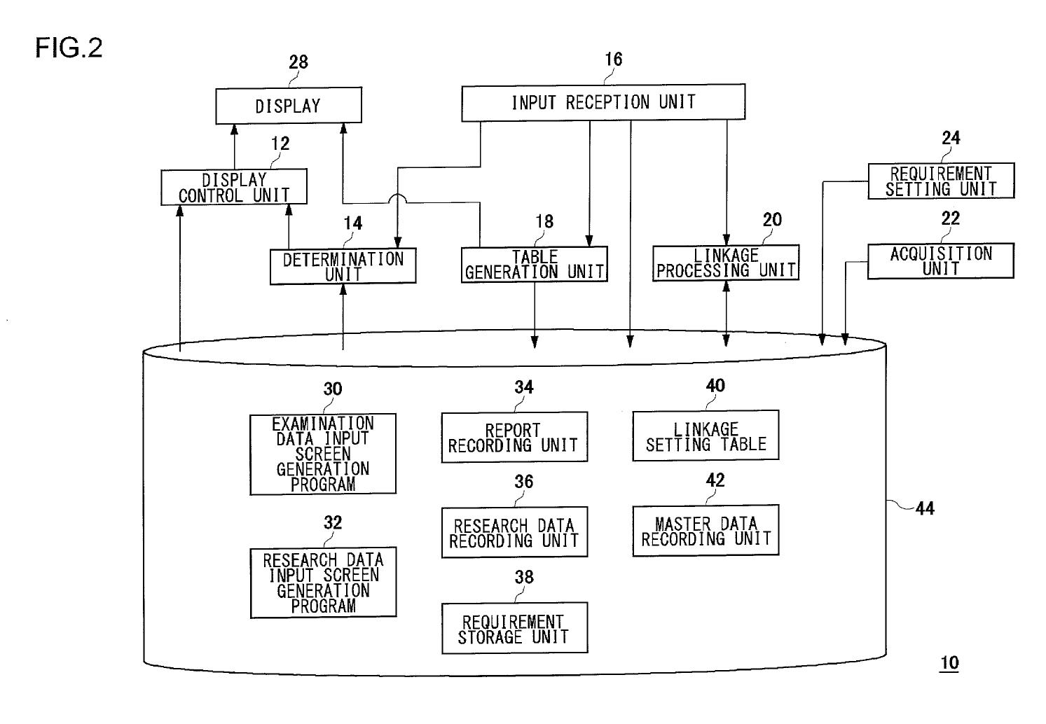

FIG. 2 illustrates the configuration of a medical information input apparatus 10. A medical information input apparatus 10 is provided with a display control unit 12, a determination unit 14, an input reception unit 16, a table generation unit 18, a linkage processing unit 20, an acquisition unit 22, a requirement setting unit 24, a display 28, and a recording unit 44. The configuration of each medical information input apparatus 10 is implemented by hardware such as a processor, a memory, or other LSIs and by software such as a program or the like loaded into the memory. FIG. 2 depicts functional blocks implemented by the cooperation of hardware and software. Thus, a person skilled in the art should appreciate that there are many ways of accomplishing these functional blocks in various forms in accordance with the components of hardware only, software only, or the combination of both.

A medical information input apparatus 10 has a function of generating a report input screen for medical personnel (hereinafter, referred to as “medical professionals”) such as doctors or the like to record daily examination tasks and then recording implementation data for examinations, etc., that is entered by a medical professional.

This function is called a “report input function” and provided to the medical information input apparatus 10 as a basic function in order to record results of medical practices. Furthermore, the medical information input apparatus 10 according to the present exemplary embodiment also has a function of generating a data input screen for recording data for academic research and recording data entered by a medical professional.

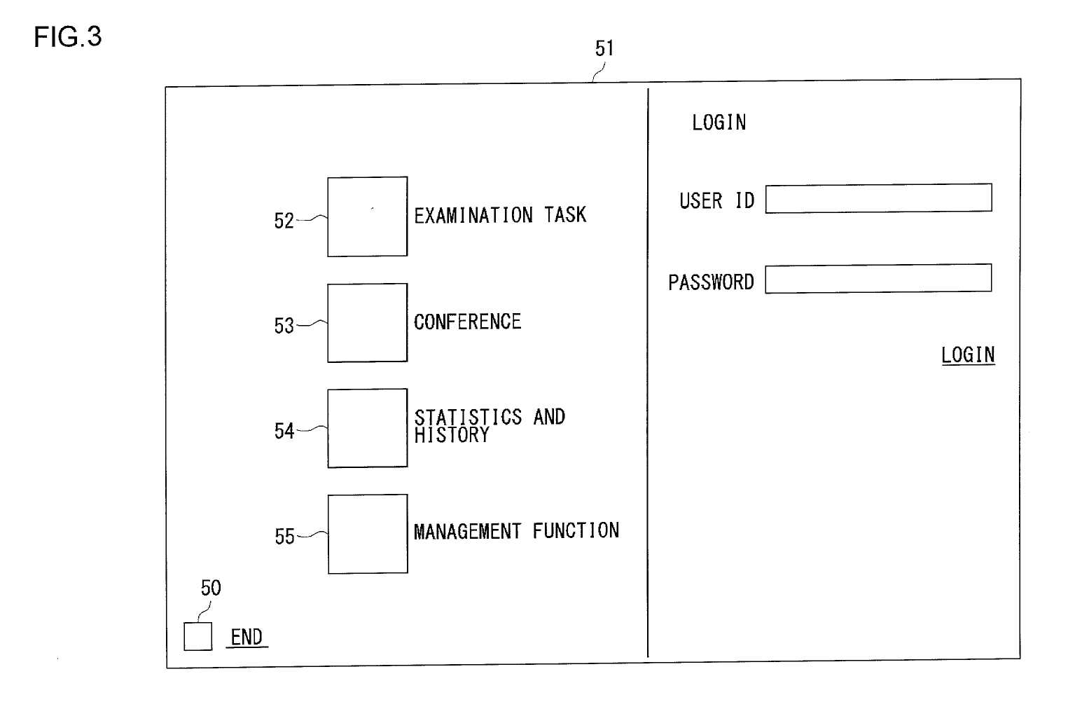

First, in reference to FIGS. 3-6, an explanation is given regarding a screen transition related to the report input function, which is defined as a basic function. The display control unit 12 generates each screen by executing an examination data input screen generation program 30 and displays the screen on the display 28. In the present exemplary embodiment, an explanation is given regarding a case where a medical information input apparatus 10 is incorporated in an endoscopic examination system and where a medical professional performs an endoscopic examination as a medical practice. The type of the medical practice may be another type of an examination or operation.

FIG. 3 illustrates a system start and end screen 51 of the endoscopic examination system. The system start and end screen 51 displays an examination task icon 52, a conference icon 53, a statistics and history icon 54, and a management function icon 55. Upon login of a medical professional by entering his/her user ID and password, respective functions corresponding to the icons become activatable. When the medical professional selects an end button 50, the system is ended.

An “examination task” function is a function used in a normal endoscopic examination task. A series of examination tasks, such as patient reception, pretreatment implementation entry, image capturing, implementation entry, report entry, and the like, can be performed.

A “conference” function allows for a search for an examination, presentation of an examination image, and presentation and editing of an examination report.

A “statistics and history” function allows for aggregation of various types of data (monthly reports, yearly reports, implementation list (daily reports), and data list by unrestricted-item settings) and for a search for a scope use history or an examination that requires follow-ups.

A “management function” is a function operated by a system manager, and access restrictions are imposed for the implementation of the function. Various types of settings used in the system, verification and integration of orders, display of transmission logs, and the like can be performed.

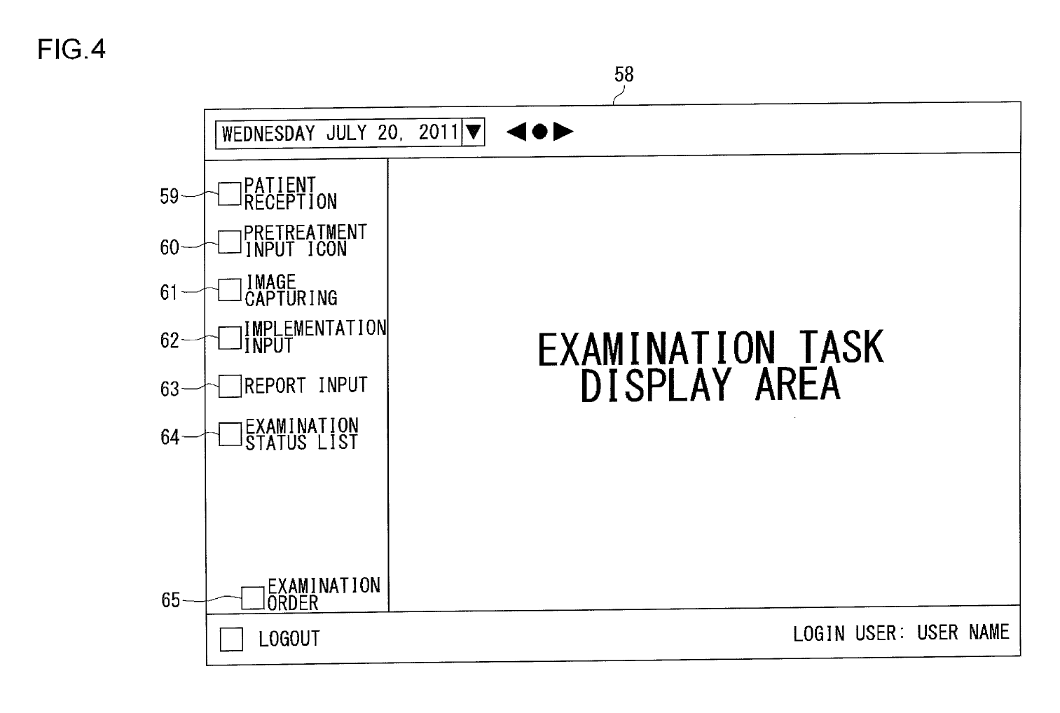

FIG. 4 illustrates an examination task main screen 58. In the system start and end screen 51 shown in FIG. 3, the examination task main screen 58 shown in FIG. 4 is started when a medical professional selects the examination task icon 52. On the left side of the screen, icons that correspond to respective examination tasks are arranged. Upon selection of an icon by the medical professional, a corresponding screen will be started. Arranged on the left side of the screen are a patient reception icon 59, a pretreatment input icon 60, an image-capturing icon 61, an implementation input icon 62, a report input icon 63, an examination status list icon 64, and an examination order button 65.

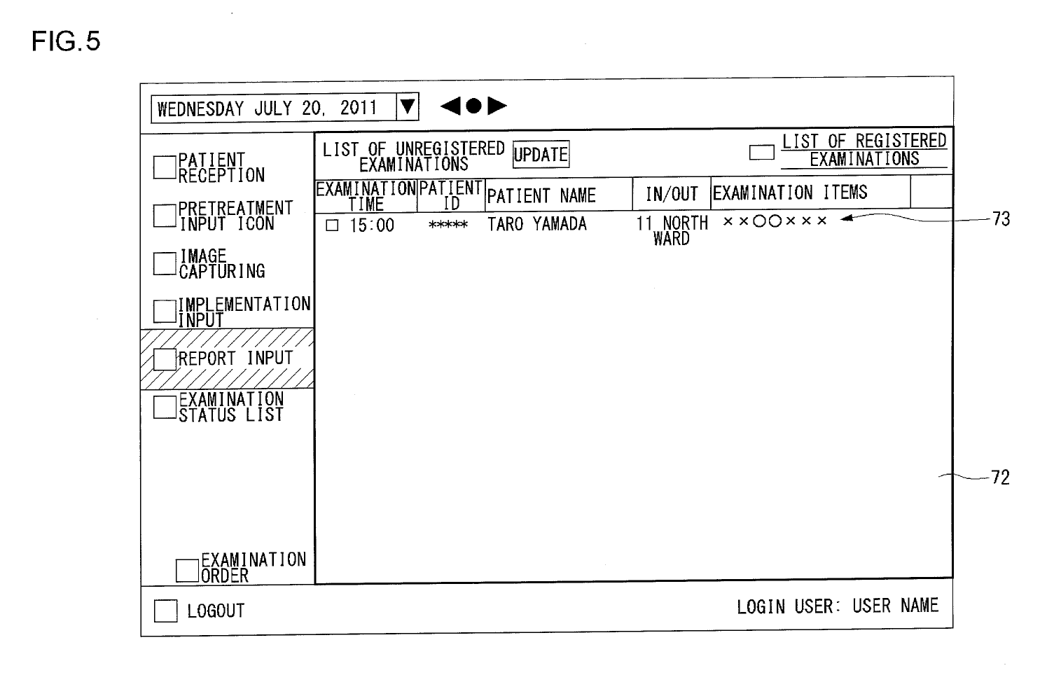

FIG. 5 illustrates a screen 72 showing a list of examinations unregistered in a report. Upon selection of the report input icon 63 by the medical professional on the examination task main screen 58 shown in FIG. 4, the screen 72 showing a list of examinations unregistered in a report, which is shown in FIG. 5, is started. The screen 72 showing a list of examinations unregistered in a report displays a patient's examination list 73 of examinations that have not been entered in a report. Shown in the examination list 73 is information for specifying examinations for which a report has not been made. As shown in the figure, the examination list 73 displays “examination time”, “patient ID”, “patient name”, “in/out” (information specifying whether or not a patient is an inpatient or an outpatient), and “examination item”. Based on these pieces of information, a medical professional selects an examination for which a report is to be made.

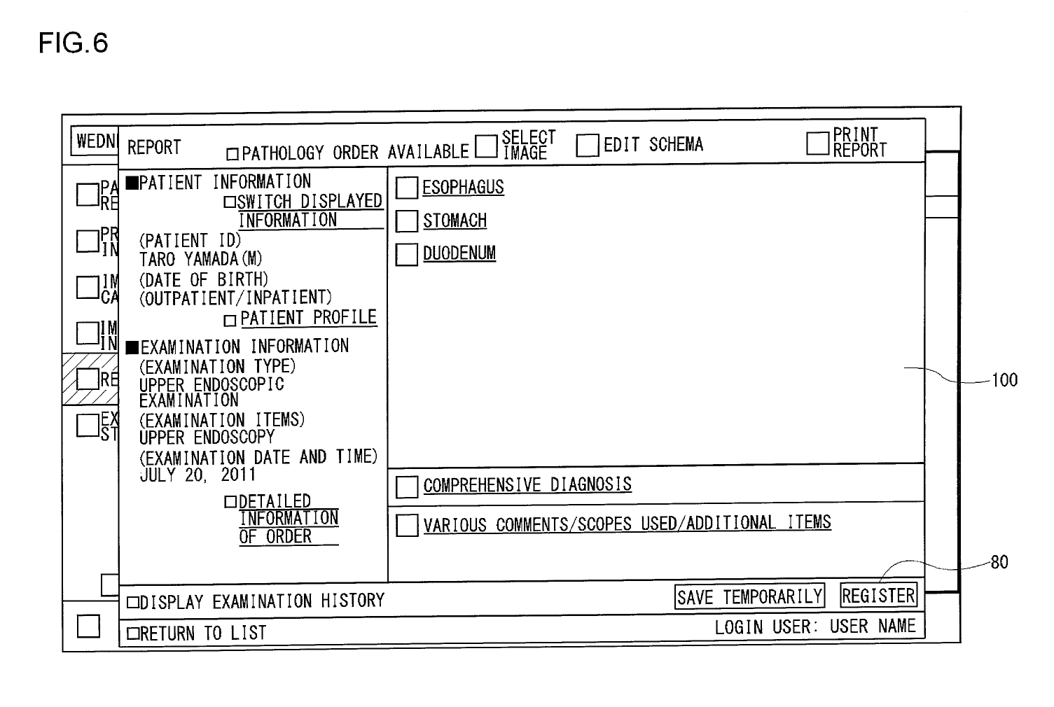

FIG. 6 illustrates a report input screen 100.

Upon selection of an examination (patient) by the medical professional on the screen 72 showing a list of examinations unregistered in a report, which is shown in FIG. 5, the report input screen 100 shown in FIG. 6 is started. An examination for a patient “Taro Yamada” is being selected in the figure. A left column of the report input screen 100 displays patient information and examination information that are linked to an examination performed on the patient “Taro Yamada”. The patient information is read out from a patient database (not shown). The examination information is read out from an examination information database (not shown) using the ID of the selected examination as a key. Both pieces of information are then entered in the left column of the report input screen 100.

A right column of the report input screen 100 displays three parts, “esophagus”, “stomach”, and “duodenum”, as the names of organs of a human body for which a report is to be entered. As shown in FIG. 6, there are areas in the report input screen 100: an area for entering observations, diagnosis, and treatment for each part of a human body; an area for entering comprehensive diagnosis; and, furthermore, an area for entering various comments/scopes used/additional items.

The medical professional selects the parts (esophagus, stomach, and duodenum) on which an endoscopic examination has been performed and enters observations, diagnosis, and treatment for the respective parts. The medical professional also selects the “comprehensive diagnosis” and enters comprehensive diagnosis. The medical professional further selects “various comments/scopes used/additional items” and enters necessary matters in accordance with preset items. For example, an input item for registering an examination purpose is included in the “various comments/scopes used/additional items”. Upon receiving input from the medical professional on the report input screen 100, the input reception unit 16 records received information in a report recording unit 34 as data that constitutes a report. When the medical professional selects a registration button 80, contents that have been entered are registered as a report, and the generation of the report is ended.

As described, when the display control unit 12 executes the examination data input screen generation program 30, the patient information and the examination information to be displayed on the left column are acquired from the respective databases, and the report input screen 100 is generated. Then, when the input reception unit 16 receives report entry from the medical professional and then records the report entry in the report recording unit 34, the report is generated.

In addition to the above-stated report input function, a medical information input apparatus 10 according to the present exemplary embodiment realizes an academic research data input function. In the medical information input apparatus 10, the report input function and the academic research data input function are realized in cooperation with each other, and the medical information input apparatus 10 provides a mechanism that allows for smooth entry of academic research data when or after a medical professional enters a report. Also, a mechanism is provided that reflects, when data to be entered in a report and data to be entered for academic research are the same or substantially the same, input to one side as input to the other side.

An explanation is given in the following regarding preconditions for the medical information input apparatus 10 to realize the academic research data input function.

The acquisition unit 22 acquires, from the academic research information management server 4, a program for generating a data input screen for academic research, a requirement for generating the data input screen for the academic research, and master data that defines data to be collected for the academic research and stores the acquired program, requirement, and master data in the recording unit 44. In the recording unit 44, a condition where a research data input screen generation program 32 is recorded is shown. When the display control unit 12 executes the research data input screen generation program 32, the data input screen for the academic research is generated and displayed on the display 28.

A requirement storage unit 38 stores the requirement for generating the data input screen for the academic research. This requirement for the generation is used to determine whether or not to generate the data input screen for the academic research. A medical information input apparatus 10 according to the present exemplary embodiment supports entry of data for academic research when a medical professional makes a report. Therefore, while input support is provided for academic research that is associated with the report being made, it is not necessary to provide input support for academic research that is not associated. The medical information input apparatus 10 determines, using the requirement stored in the requirement storage unit 38, whether or not it is necessary to provide input support for data used for academic research and provides the input support only when it is determined necessary.

A master data recording unit 42 records master data in academic research. Master data constitutes data collected for academic research. The research data input screen generation program 32 generates a data input screen for the academic research by using master data recorded in the master data recording unit 42.

If a plurality of pieces of academic research are in progress in the academic research participating facilities 6, the respective acquisition units 22 acquire, for each piece of academic research, a program, a requirement, and master data for generating a data input screen designated for academic research and store the acquired program, requirement, and master data in the recording unit 44. The requirement for the generation of a research data input screen stored in the respective requirement storage units 38 may be editable in a medical information input apparatus 10. For example, in a case where a plurality of doctors belong to the academic research participating facilities 6, some doctors participate in academic research, while other doctors do not participate. If doctors who are participating in academic research are identified for each academic research participating facility 6 in the academic research information management server 4, information identifying the doctors may be included in a requirement acquired by respective acquisition units 22 from the academic research information management server 4. However, in reality, the academic research information management server 4 often does not keep in track of such information, and doctors who are participating in academic research are often determined fluidly in the academic research participating facilities 6. Thus, in each academic research participating facility 6, a manager is allowed to modify or change a requirement stored in a requirement storage unit 38 through a requirement setting unit 24. Note that an acquisition unit 22 does not necessarily acquire a requirement for the generation of a data input screen for academic research from the academic research information management server 4. In this case, a manager will set the requirement through a requirement setting unit 24.

In the following, it is assumed that a research theme titled “Upper Endoscopy Atrophy and CA Related Study” is in progress as single academic research. The requirement storage unit 38 stores requirements for generating a data input screen for the study theme “Upper Endoscopy Atrophy and CA Related Study”. Requirements for generating a research data input screen can be divided into requirements related to medical professionals who are participating in the research theme, requirements related to examinations, and the like.

<Requirements Related to Medical Professionals>

Requirements related to medical professionals are often set by a manager of an academic research participating facility 6 through a requirement setting unit 24 mainly in a medical information input apparatus 10.

It is preferred that a research data input screen be started when a medical professional participating in academic research is logged into an endoscopic examination system. On the other hand, it is not preferred that the research data input screen be started when a medical professional who is not participating in the academic research is logged in. Therefore, a manager of the medical information input apparatus 10 includes, through a requirement setting unit 24, the IDs of participating medical professionals in requirements for generating research data input screen in advance for each academic research theme. For example, it is possible to separate people who are entering data based on the authority of medical professionals. For example, it is a case where doctors are allowed to enter data while assistants such as technicians and the like are not allowed to enter data. In such a case, the manager of the medical information input apparatus 10 sets, through the requirement setting unit 24, a requirement for generating a screen such that doctors are given a permission to enter data while assistants are not given a permission to enter data.

In the medical information input apparatus 10, information on a medical professional is identified by a user ID that is entered in the system start and end screen 51 shown in FIG. 3. If a requirement related to medical professionals has been set as the requirement for generating a screen, the determination unit 14 determines whether or not the requirement is satisfied based on: the requirement that has been set; the name of a medical professional identified by a user ID; the authority of the medical professional; and the like.

<Requirements Related to Examinations>

Requirements related to examinations are set in the academic research information management server 4 and distributed to a plurality of academic research participating facilities 6.

A typical requirement related to examinations is an examination type. In the case of general endoscopic examinations, a type specifying either an upper endoscopic examination or a lower endoscopic examination is often determined to be an academic research theme. Requirements related to various examinations are set according to an academic research theme such as a specific case, a diagnostic outcome, patient's sex, age, etc. If a requirement related to examinations has been set as the requirement for generating a screen, the determination unit 14 determines whether or not the requirement related to the examinations is satisfied in a condition where a report input screen is being generated.

An explanation is given regarding a requirement determination process performed by the determination unit 14.

In a condition where the display control unit 12 is generating a report input screen, the determination unit 14 determines whether or not a requirement stored in the requirement storage unit 38 is satisfied. When the report input screen is displayed on the display 28, the medical professional enters an examination status, a diagnostic outcome, and the like so as to generate a report. The report thus generated includes information constituting the report input screen before the data entry by the medical professional. The determination unit 14 determines whether or not the information constituting the report input screen and the information entered through the report input screen by the medical professional satisfy the requirement stored in the requirement storage unit 38.

The “information constituting the report input screen” includes patient information and examination information that are displayed on the left column in the report input screen 100 shown in FIG. 6. Included in the left column of the report input screen 100 are the patient information and the examination information. The patient information includes the name, sex, date of birth, and the like of a patient. The examination information includes an examination type, an examination item, an examination date and time, and the like. If the patient's sex, age, etc., are included in the requirement stored in the requirement storage unit 38, the determination unit 14 determines whether or not the requirement is satisfied in reference to the patient information.

The “information entered through the report input screen” includes input information such as an examination status, a diagnostic outcome, and the like entered by the medical professional in the report input screen 100 shown in FIG. 6. In other words, the “information entered through the report input screen” corresponds to substantial contents of a report to be generated and includes information such as symptoms of a patient, the status of progress of the symptoms, and the like. If the requirement storage unit 38 stores a specific symptom as the requirement for generating a screen, the determination unit 14 determines that the requirement for generating the screen related to the symptom is satisfied when the symptom is entered into the report input screen 100 by the medical professional.

To explain using an example shown in FIG. 6, if an examination item is set to be an upper endoscopy as the requirement stored in the requirement storage unit 38, an examination item of the report is also an upper endoscopy as shown in the left column of the report input screen 100. Therefore, the determination unit 14 determines that the examination information of the report satisfies the requirement stored in the requirement storage unit 38. For example, if the examination item is set to be a lower endoscopy as the requirement stored in the requirement storage unit 38, the determination unit 14 determines that the examination information of the report does not satisfy the requirement stored in the requirement storage unit 38.

When the determination unit 14 determines that the requirement stored in the requirement storage unit 38 is satisfied, the display control unit 12 generates a data input screen for academic research on condition that a predetermined button created on the report input screen 100 has been pressed. The data input screen for academic research may be directly generated by pressing the predetermined button. Alternatively, the data input screen for academic research may be generated via a selection window for selecting an academic research theme, as described later. In the example shown in FIG. 6, the medical professional enters implementation data for the examination into the report input screen 100, and, when the generation of the report is completed by pressing the registration button 80, the display control unit 12 generates the data input screen for academic research upon the pressing of the registration button 80. As described, the display control unit 12 automatically generates the data input screen for related academic research on condition that the registration button 80 for showing the completion of the entry of the report has been pressed. This prevents the medical professional from forgetting to enter data for the academic research so that the medical professional can enter data that is necessary for the academic research in conjunction with daily tasks.

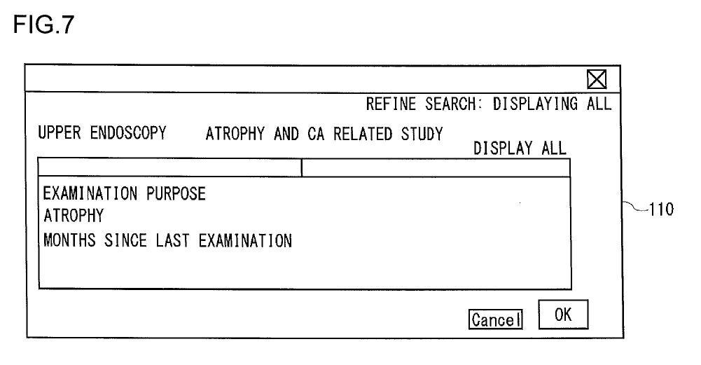

FIG. 7 illustrates a research data input screen 110. If the registration button 80 is pressed while the requirement stored in the requirement storage unit 38 is being satisfied, the display control unit 12 reads out the research data input screen generation program 32 from the recording unit 44 and executes the research data input screen generation program 32. This allows the medical professional to complete the generation of the report and to uninterruptedly enter data for the academic research into the research data input screen 110. As described, by linking the entry of the report with the entry of the academic research data, tasks of the busy medical professionals can be smoothly supported.

In order to provide a reminder for the entry of the implementation data for the academic research in association with the report being entered, the display control unit 12 may actively create a button for displaying a research data input screen in addition to the registration button 80.

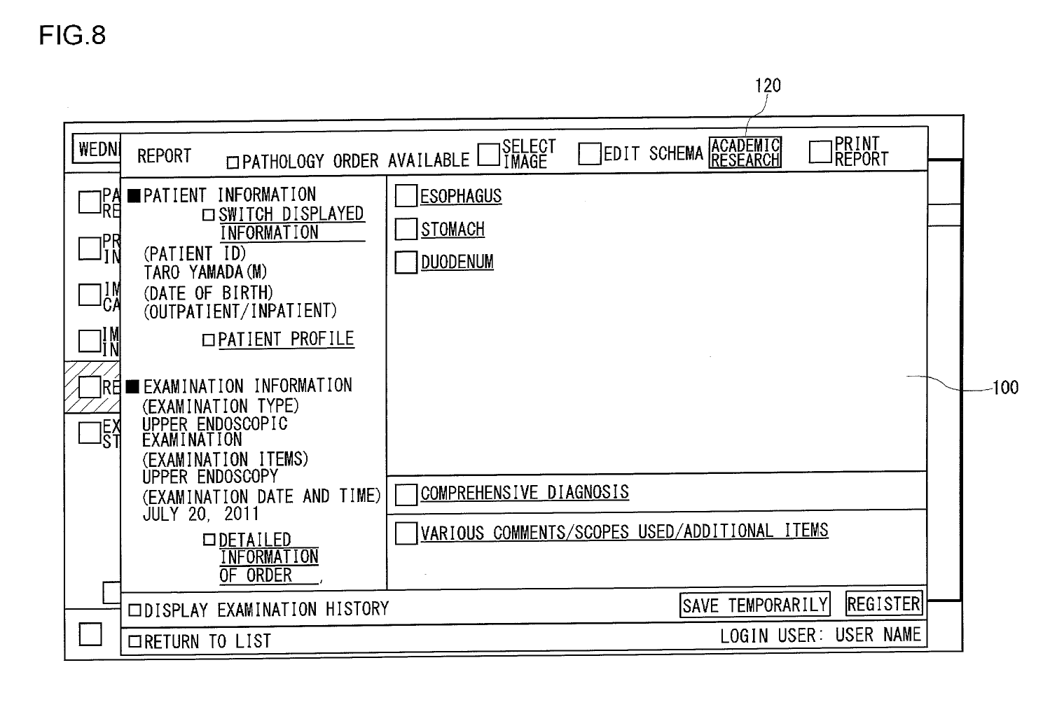

FIG. 8 illustrates a report input screen 100 in which a display button 120 for the research data input screen is generated. When the determination unit 14 determines that the requirement stored in the requirement storage unit 38 is satisfied, the display control unit 12 generates, on the report input screen 100, the display button 120 for displaying the research data input screen 110. By checking the display button 120 being displayed, the medical professional can remember to enter the implementation data for the academic research. Also, by pressing the display button 120, the medical professional can display the research data input screen 110 on the display 28.

When the requirement stored in the requirement storage unit 38 is satisfied, the display control unit 12 generates the display button 120 on the report input screen 100. Therefore, if the determination unit 14 determines that the entered implementation data satisfies the requirement for generating the screen stored in the requirement storage unit 38 while the medical professional is entering the implementation data into the report input screen 100, the display control unit 12 generates the display button 120 at that timing. The requirement storage unit 38 stores requirements for generating a screen for a plurality of academic research themes. Thus, it is preferred that the display control unit 12 show the medical professional that data entry is necessary for a plurality of pieces of academic research if the requirements for generating a screen for the plurality of academic research themes are being satisfied when the report input screen 100 is displayed. Therefore, for example, the number of pieces of related academic research may be included inside or near the display button 120. Alternatively, the same number of display buttons 120 as the number of corresponding items of academic research may be displayed. Furthermore, the notation of a display button 120 may be changed from commonly-used “academic research”, as shown in the figure, to a notation that allows for the identification of academic research, and separate display buttons 120 may be generated. This allows the medical professional to learn the number of academic research themes for which data entry is to be performed.

As described previously, a direct transition to a research data input screen 110 may be performed after a display button 120 is pressed. Alternatively, a selection window for selecting an academic research theme may be displayed once so that a transition to a research data input screen 110 is performed after the medical professional selects an academic research theme.

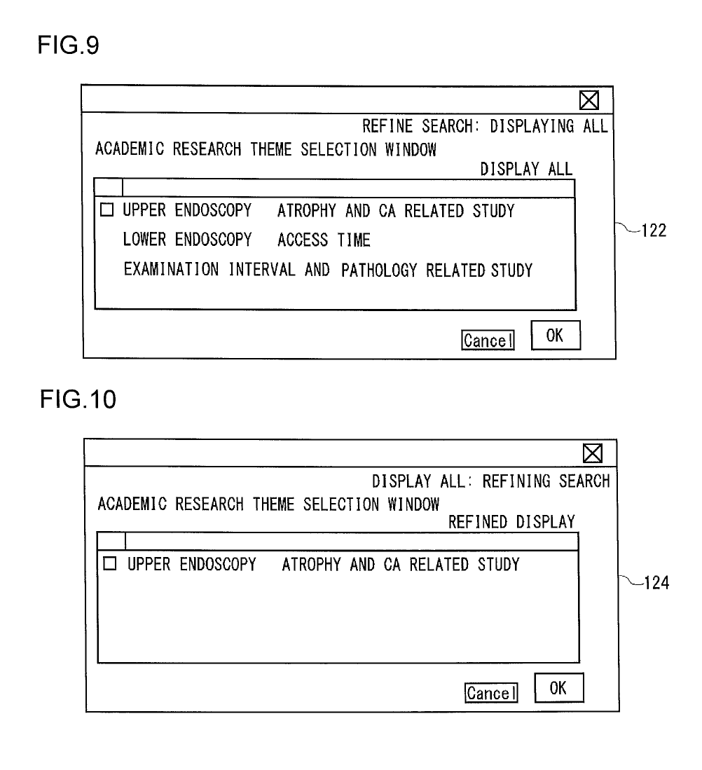

FIG. 9 illustrates a selection window 122 for selecting an academic research theme. This selection window 122 may be displayed in a superimposed manner on the report input screen 100 shown in FIG. 8. In the selection window 122, the titles of all academic research themes that are in progress in the academic research participating facilities 6 are displayed, as noted as “displaying all” in the upper right. For an academic research theme related to a report being generated, in other words, for an academic research theme for which a requirement for generating a screen is determined to be satisfied by the determination unit 14, a check box is created on the left side of a theme title. By entering a check in the check box, the medical professional can select the academic research theme.

In the selection window 122 shown in FIG. 9, a theme, “Upper Endoscopy Atrophy and CA Related Study”, is related to the report being generated. Therefore, when the medical professional enters a check in the check box and presses an OK button, the display control unit 12 generates a research data input screen 110 for “Upper Endoscopy Atrophy and CA Related Study” and displays the generated research data input screen 110 on the display 28. If a plurality of academic research themes are related to the report being generated, a check box is created on the left side of each theme title.

FIG. 10 illustrates another example of a selection window 124 for selecting an academic research theme. As “refining search” is displayed in the upper right, this selection window 124 displays only the title of an academic research theme related to the report being generated, that is, an academic research theme for which a requirement for generating a screen is determined to be satisfied by the determination unit 14. In the selection window 124, only the theme title, “Upper Endoscopy Atrophy and CA Related Study”, is displayed. If a plurality of academic research themes are related to the report being generated, respective theme titles are displayed, and a check box is created on the left side of each of the theme titles. When the medical professional enters a check in the check box and presses an OK button, the display control unit 12 generates a research data input screen 110 and displays the generated research data input screen 110 on the display 28.

Explained above is a function for a transition from the report input screen 100 to the research data input screen 110. This function allows the medical professional to remember to enter data for academic research after report entry, and efficient support can thus be provided for medical professional's tasks.

In general, a medical record for daily tasks entered in a report is not the same as a medical record entered for academic research. However, some data is often the same. As described above, the medical information input apparatus 10 according to the present exemplary embodiment sequentially displays a research data input screen 110 after a report input screen 100 on the display 28 so as to support data entry performed by a medical professional. However, it is not preferred that a different value be entered for the same input item by mistake in each of the data input screens. Thus, the medical information input apparatus 10 has a function of processing information entered for an item of the report input screen 100 as information entered for the same item in the research data input screen 110.

If a plurality of pieces of academic research are in progress in the same academic research participating facility 6, there may be items that are the same among respective master data items of the academic research. Thus, for a plurality of academic research themes, the medical information input apparatus 10 also has a function of processing, for items that are the same, information entered in one research data input screen 110 as information entered in other research data input screens 110.

In order to achieve this data linkage function, the table generation unit 18 generates a linkage setting table 40 that associates items that are the same with one another among a plurality of pieces of master data in the medical information input apparatus 10.

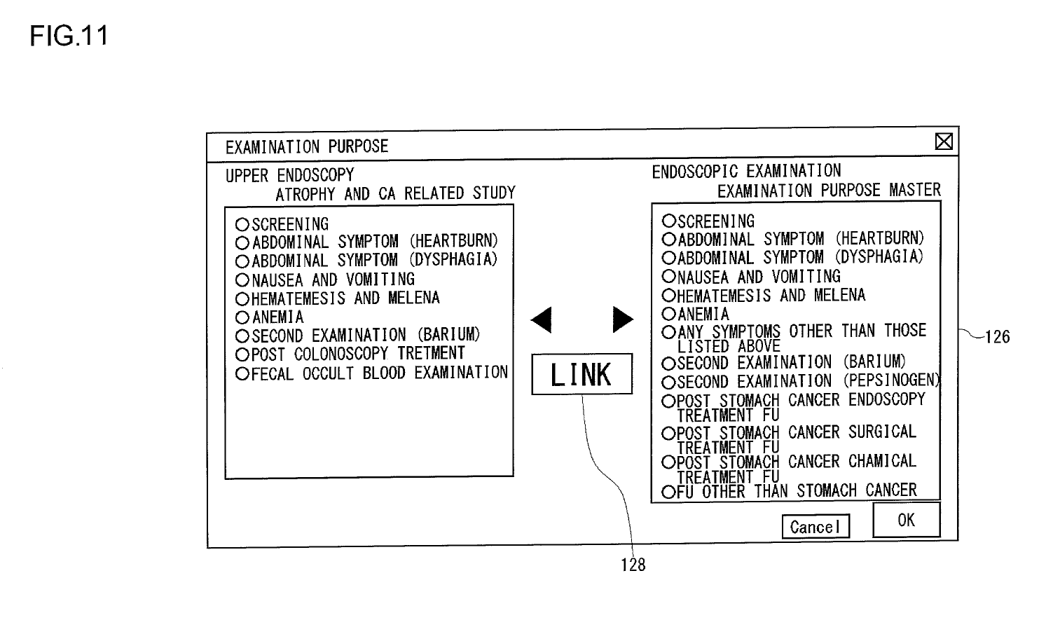

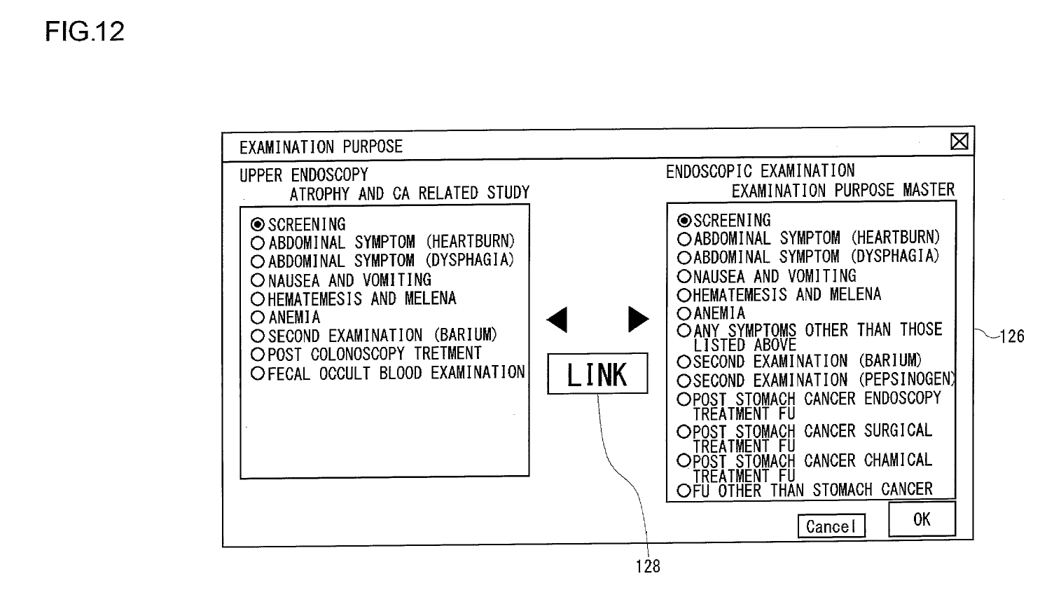

FIG. 11 illustrates an example of a GUI (Graphical User Interface) for linking master data for academic research to master data for an endoscopic examination. After master data for academic research is registered in the master data recording unit 42, a master data association process can be performed. When the medical professional activates a GUI function of the table generation unit 18 and selects both the master data for academic research and the master data for an endoscopic examination, the table generation unit 18 generates a GUI 126 for linkage shown in FIG. 11. When the medical professional selects an item under “Upper Endoscopy Atrophy and CA Related Study” in the left column and an item under “Endoscopic Examination Examination Purpose Master” in the right column and then presses an association button 128, the table generation unit 18 associates the selected items with each other.

FIG. 12 illustrates an example where master data items are associated with each other. When the medical professional selects an item, “Screening”, under “Upper Endoscopy Atrophy and CA Related Study” in the left column and an item, “Screening”, under “Endoscopic Examination Examination Purpose Master” in the right column and then presses the association button 128, the table generation unit 18 associates the selected items with each other. When an OK button is pressed after this associating operation is performed for a plurality of items, associated items are recorded in the linkage setting table 40. The respective names of items to be associated do not need to be the same in respective master data. There are some medical terms for which unified names are not used. Also, there are some medical terms that are called in different names in the plurality of academic research participating facilities 6. Therefore, a name used in the master data for academic research may not be used in the academic research participating facilities 6. On the GUI shown in FIG. 12, a single medical term is sometimes displayed in different expressions in right and left columns. Therefore, the medical professional who performs the associating operation may recognize inconsistent spellings in both sets of master data so as to associate data items with each other.

By the above associating process, the linkage setting table 40 associating an input item of the report input screen 100 with an input item of the research data input screen 110 is generated. In each data input screen, when the input reception unit 16 receives data entry, the linkage processing unit 20 processes information entered to either one of the report input screen 100 and the research data input screen 110 as input information entered to the other screen in reference to the linkage setting table 40. For example, in a case where information for a given input item is entered in the report input screen 100, if the input item is associated with an input item in the research data input screen 110 in the linkage setting table 40, the linkage processing unit 20 records the information in the research data recording unit 36 on the assumption that the same information is also entered into the corresponding input item in the research data input screen 110. Similarly, in a case where information for a given input item is entered in the research data input screen 110, if the input item is associated with an input item in the report input screen 100 in the linkage setting table 40, the linkage processing unit 20 records the information in the report recording unit 34 on the assumption that the same information is also entered into the corresponding input item in the report input screen 100.

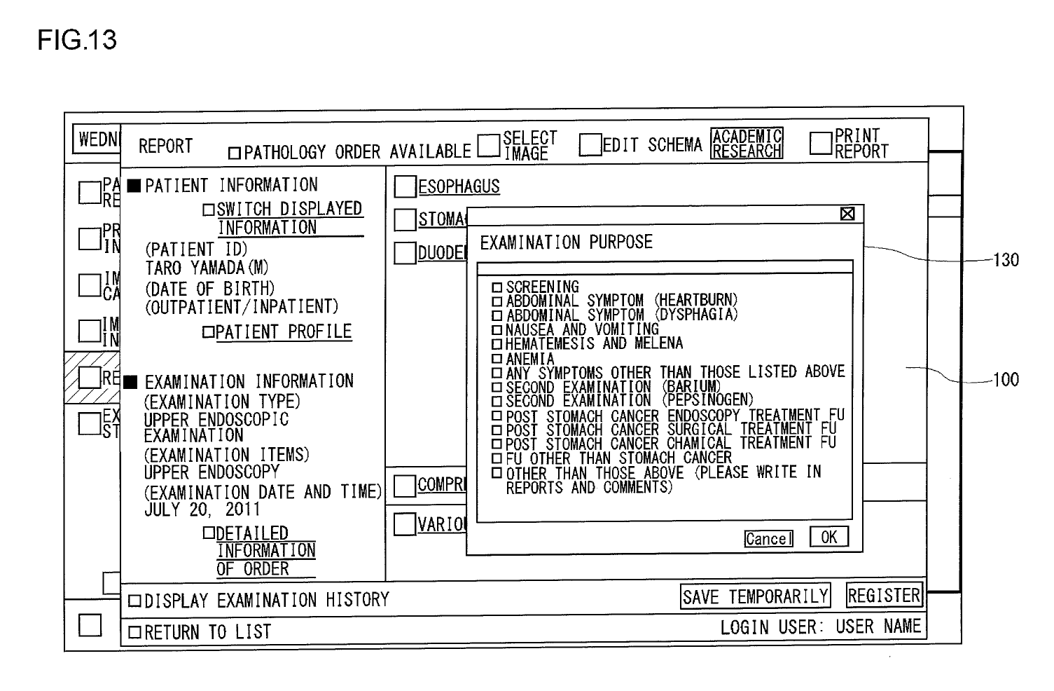

FIG. 13 illustrates a selection window 130 displayed during report entry. When a medical professional selects the column, “various comments/scopes used/additional items”, in the report input screen 100 shown in FIG. 8, the selection window 130 is displayed in a superimposed manner on the report input screen 100. The selection window 130 is formed as a screen for entering examination purposes.

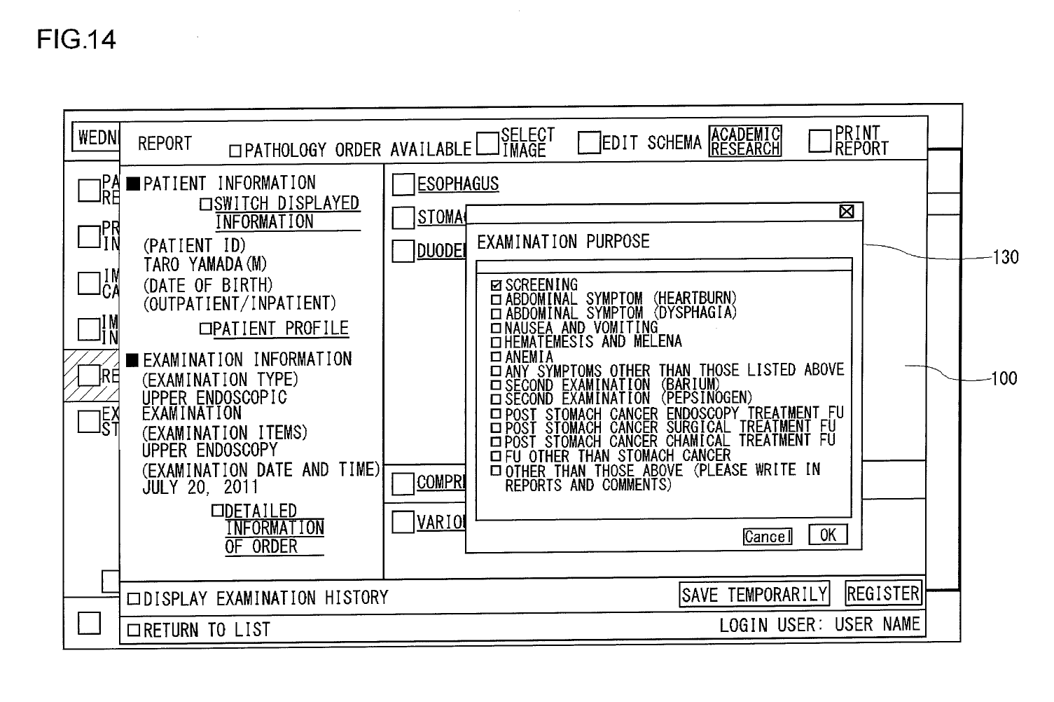

FIG. 14 illustrates a condition where an item in the selection window 130 is being selected. In this case, a medical professional has selected “Screening” as an examination purpose.

Upon receiving selection input of “Screening” on the report input screen 100, the input reception unit 16 records the selection input in the report recording unit 34 and notifies the linkage processing unit 20 that there has been selection input of “Screening” on the report input screen 100. In reference to the linkage setting table 40, the linkage processing unit 20 checks whether an item in the research data input screen 110 is associated with the “Screening” item in the report input screen 100. Since both “Screening” items are associated with each other in this case, the linkage processing unit 20 updates the status value of the “Screening” item of the research data recording unit 36 to a status value obtained at the time the selection input is entered. As described above, by processing information entered in one data input screen as information entered in the other data input screen by the linkage processing unit 20 in reference to the linkage setting table 40, a medical professional can save the trouble of entering data for the same item and reduce possibilities for entering errors in a plurality of data input screens.

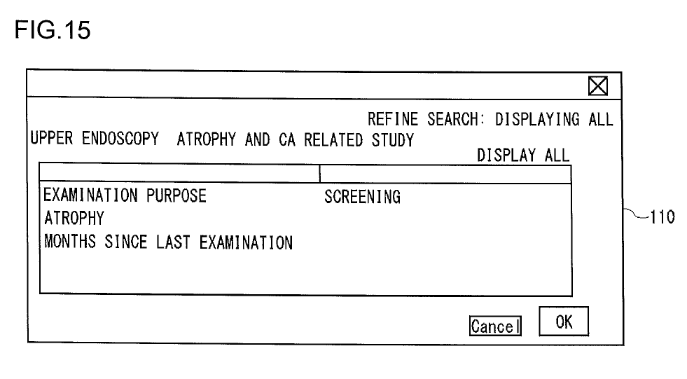

FIG. 15 illustrates a research data input screen 110. When the display button 120 (or the registration button) is pressed in the report input screen 100 shown in FIG. 8, the display control unit 12 reads out the research data input screen generation program 32 from the recording unit 44 and executes the research data input screen generation program 32. As shown in the figure, “Screening” entered in the report input screen 100 is reflected in a column for examination purposes. For example, reflected information may be set to be uneditable so that information entered in the report input screen 100 cannot be changed. Alternatively, information entered in the report input screen 100 may be changed by editing reflected information. In either case, by reflecting input information entered into the report input screen 100 in input information entered into the research data input screen 110, a medical professional can check the information entered into the report input screen 100, and the need for re-entering can be eliminated. Thus, highly-reliable data entry can be supported.

Described above is an explanation of the present invention based on the embodiments. These embodiments are intended to be illustrative only, and it will be obvious to those skilled in the art that various modifications to constituting elements and processes could be developed and that such modifications are also within the scope of the present invention.

What is claimed is:

1. A medical information input apparatus comprising:
a display control unit configured to generate a first input screen for entering information on medical practices and a second input screen for entering information on academic research;
an input reception unit configured to receive information input entered from a user on the first input screen and the second input screen;
a recording unit configured to record the information entered through the first input screen and the second input screen;
a requirement storage unit configured to store a requirement for generating the second input screen; and
a determination unit configured to determine whether or not the requirement stored in the requirement storage unit is satisfied,
wherein, when the determination unit determines that the information received from the user on the first input screen by the input reception unit satisfies the requirement stored in the requirement storage unit, the display control unit generates the second input screen on condition that a predetermined button created on the first input screen has been pressed.

2. The medical information input apparatus according to claim 1, wherein the display control unit generates a display button for displaying the second input screen when the determination unit determines that the requirement stored in the requirement storage unit is being satisfied.

3. The medical information input apparatus according to claim 2, wherein the display control unit displays the display button on the first input screen when the determination unit determines that the requirement stored in the requirement storage unit has been satisfied during display of the first input screen.

4. The medical information input apparatus according to claim 1 further comprising: a linkage processing unit configured to process information entered into either one of the first input screen and the second input screen as input information entered into the other input screen.

5. The medical information input apparatus according to claim 4 further comprising:
a linkage setting table associating an input item in the first input screen with an input item in the second input screen,
wherein the linkage processing unit processes, in reference to the linkage setting table, the information entered into either one of the first input screen and the second input screen as the input information entered into the other input screen.

6. The medical information input apparatus according to claim 1 further comprising: a requirement setting unit configured to allow the requirement stored in the requirement storage unit to be modified or changed.
